(19) United States
(12) Patent Application Publication
(10) Pub. No.: US 2025/0250490 A1
(43) Pub. Date: Aug. 7, 2025

(54) Methods and Apparatus for Reduction of Contaminants in Crude Oil

(71) Applicant: Hydro Dynamics, Inc., Rome, GA (US)

(72) Inventors: Gerard J. Broussard, Saint Martinville, LA (US); Dale Patrick Martin, JR., Youngsville, LA (US); Daniel A. Armstead, Cartersville, GA (US)

(21) Appl. No.: 19/042,854

(22) Filed: Jan. 31, 2025

Related U.S. Application Data
(60) Provisional application No. 63/548,633, filed on Feb. 1, 2024.

(51) Int. Cl. C10G 32/02; B01F 27/70; B01F 31/00; B01F 35/32; B01F 35/33; B01F 101/00; C10G 29/02; C10G 29/04

(52) U.S. Cl. CPC C10G 32/02; B01F 27/70; B01F 31/00; B01F 35/3204; B01F 35/331; C10G 29/02; C10G 29/04; B01F 2101/2204; C10G 2300/1037

(57) ABSTRACT

A system and method for dynamically reducing sulfur and other contaminants in a crude oil feedstock. The method includes pumping a crude oil feedstock into an inlet of a cavitation reactor and rotating a rotor of the cavitation reactor to induce cavitation events within the crude oil feedstock by formation and collapse of unstable bubbles that resultingly induce shockwaves to propagate through the crude oil feedstock, which further causes mixing and rapid reaction under mild/low to moderate shear forces that reduces damage to the resulting fuel product.

### CROSS REFERENCE

The present co-pending application claims benefit of U.S. Provisional Patent Application No. 63/548,633, filed Feb. 1, 2024.

### INCORPORATED BY REFERENCE

U.S. Provisional Patent Application No. 63/548,633, filed Feb. 1, 2024, are incorporated by reference herein for all purposes as if set forth in its entirety.

### FIELD OF THE INVENTION

The present disclosure relates generally to reducing contaminants in a fuel product. More specifically, embodiments relate to a method and apparatus for controlled cavitation with a feedstock stream to reduce contaminant content present in the feedstock stream.

### BACKGROUND OF THE INVENTION

Crude oil is the world's main source of hydrocarbons used as fuel and petrochemical feedstock while also being a major source for air and water pollution. Unrefined crude oil contains various impurities, and contaminants such as sulfur. Such contaminants can be detrimental to both the refining process and the environment. For example, when crude oil is burned or processed, sulfur compounds in the oil can react with oxygen to form sulfur dioxide (SO2) and other sulfur oxides. Such sulfur compounds are major contributors to air pollution and can lead to the formation of acid rain, which can harm the environment, including causing significant damage ecosystems, and corrode buildings and infrastructure, and can also have adverse effects on human health, particularly for those with respiratory conditions like asthma. While the exact compositions of natural petroleum or crude oils vary significantly, all crude oils contain some measurable amount of sulfur compounds. For example, sulfur concentrations in crude oils can range from about 0.5 to about 1.5 wt. %.

Reducing contaminant content in crude oil helps mitigate these health risks associated with air pollution. Contaminants in crude oil also can interfere with the refining process and contribute to the corrosion of refinery equipment and pipelines, as well as causing reductions in the quality of the end petroleum products, such as gasoline, diesel, and jet fuel. To address growing pollution concerns, many countries have implemented strict regulations on petroleum products, particularly on petroleum-refining operations and the allowable concentrations of specific pollutants in fuels, such as the allowable sulfur content in hydrocarbon feedstock.

Moreover, many countries, including the United States, have imposed strict regulations on the sulfur content in refined fuels to reduce air pollution. It therefore is important to remove such sulfur compounds and other contaminants from crude oil, but to do so in such a way that the fuel quality is not decreased, and production costs are not increased. The process of removing sulfur from crude oil is generally known as desulfurization. There are several desulfurization methods, including low pressure conventional hydrodesulfurization (HDS), which can be used to remove a major portion of the sulfur from petroleum distillates for the blending of refinery transportation fuels.

Many of current processes for removing contaminants and sulfur from crude oil and other materials such as fuels and/or petrochemicals, are costly, however, and can produce troublesome byproducts or can damage the fuel quality. A need therefore exists for an efficient, simple and effective process for substantially eliminating or controlling the content of contaminants in crude oil as part of a refining process, which addresses the foregoing and other related and unrelated problems in the art, including without causing damage to the crude oil and which produces minimal environmentally unfriendly byproducts during use. It is to the provision of such a process that the present disclosure is primarily directed.

### SUMMARY

Aspects and advantages of the disclosure will be set forth in part in the following description, or may be obvious from the description, or may be learned through practice of the invention.

In one aspect, the disclosure includes a method of reducing contaminants in a fuel product, which may include: feeding a crude oil feedstock along a flow path; as the crude oil feedstock moves along the flow path, adding one or more dosing agents into the crude oil feedstock to form a mixture of the crude oil feedstock and the one or more dosing agents; regulating a temperature of the mixture; directing the mixture into a cavitation zone of a cavitation reactor; as the mixture flows through the cavitation zone of the cavitation reactor, operating the cavitation reactor and generating cavitation events within the mixture; and where generating the cavitation events within the mixture may include forming cavitation bubbles within the mixture and collapsing the cavitation bubbles so as to generate cavitation induced pressure variations that propagate through the mixture as the mixture flows through the cavitation zone so as to cause increased reaction and blending of the one or more dosing agents with the crude oil feedstock of the mixture under low to moderate shear conditions so as to reduce damage to the fuel product, substantially contaminants from the crude oil feedstock, substantially reduce a viscosity of the crude oil feedstock to a selected viscosity, or combinations thereof.

In an exemplary embodiment, the cavitation reactor may include a cavitation chamber and a rotor rotatably mounted within the cavitation chamber, the rotor having at least one rotor blade having a peripheral surface with a plurality of cavitation bores defined therethrough; where the cavitation zone is defined within a space between the peripheral surface of the at least one rotor blade and an inner surface of the cavitation chamber; and where operating the cavitation reactor further may include rotating the rotor at a selected rotation rate to create a low pressure in the cavitation bores sufficient to cause the formation and collapse of the cavitation bubbles so as to generate shockwaves that create the cavitation induced pressure variations that propagate through the mixture.

In an exemplary embodiment, operating the cavitation reactor further may include controlling a rotor rotation rate in view of a concentration of the one or more dosing agents within the mixture, and controlling a dwell time of exposure of the mixture to the cavitation induced pressure variations, a temperature of the mixture, a range of pressures of the cavitation induced pressure variations, or combinations thereof.

In an exemplary embodiment, the one or more dosing agents may include a bioenzyme, an oxidant, surfactant, nitrogen, ambient air, or combinations thereof.

In an exemplary embodiment, the one or more of dosing agents may include asphaltenes, paraffins, nitrogen, ozone, oxygen, peroxide, manganese, silica, carbon, graphite, polymers, surfactants, water, or combinations thereof.

In an exemplary embodiment, the contaminants may include one or more of sulfur, chlorides, metal ions, metals, or combinations thereof.

In an exemplary embodiment, introducing one or more dosing agents into the crude oil feedstock may include passing the crude oil feedstock through a mixing chamber, and introducing the one or more dosing agents into the mixing chamber through at least one dosing port; wherein the one or more dosing agents are introduced into the mixing chamber at a rate of approximately 0.1% or less in gallons per min/liters per sec versus a rate of flow of the crude oil feedstock through the mixing chamber.

In an exemplary embodiment, the method may further include refining the fuel product to form a diesel fuel, a light fuel, a heavy fuel, a fuel condensate, gasoline, heating oil, natural gas products, or liquidized coal.

In an exemplary embodiment, the method may further include adding a condensate, water, caustic, ionic liquid, or other materials to the fuel product to solubilize the one or more contaminants therein.

In an exemplary embodiment, the method may further include applying an electrical current to the mixture so as to create an electrical potential difference within the mixture sufficient for driving an electrochemical reaction in combination with generating the cavitation events within the mixture so as to control formation of radical and intermediate species of contaminants within the mixture at conventional or increased proceeded fuel feedstock production levels with reduced fossil fuel product damage.

In one aspect, the disclosure includes a system for reducing contaminants in a fuel product, which may include: a supply of a crude oil feedstock; a mixing chamber connected to the supply of the crude oil feedstock, the mixing chamber including body having a flow passage defined therethough; where the mixing chamber is configured to add at least one dosing agent to the crude oil feedstock as crude oil feedstock is moved along the flow passage through the mixing chamber to form a mixture of the at least one dosing agent and the crude oil feedstock; a cavitation reactor in communication with the mixing chamber; wherein the cavitation reactor may include a cavitation chamber and a rotor positioned within cavitation chamber; wherein a cavitation zone is defined between a surface of the rotor and a surface of the cavitation chamber; wherein the crude oil feedstock is fed from the supply into the mixing chamber; and wherein the cavitation reactor is configured to receive the mixture from the mixing chamber and rotate the rotor to generate shockwaves of a magnitude within the mixture to induce cavitation induced pressure variations that propagate through the mixture sufficient to cause an increased reaction between produced radicals and contaminants present in the crude oil feedstock under low to moderate shear to separate at least a portion of the contaminants from the crude oil feedstock while minimizing damage to the fuel product.

In an exemplary embodiment, the rotor of the cavitation reactor further may include at least one rotor blade having a plurality of cavitation bores extending therethrough; and wherein rotation of the rotor at a selected rotation rate induces substantially continuous cavitation events within the plurality of cavitation bores of the rotor by creation of low pressure in the cavitation bores of the rotor so as to cause formation and collapse of unstable bubbles to create the shockwaves within the crude oil feedstock within the cavitation zone.

In an exemplary embodiment, the mixing chamber further may include: an inlet located at an upstream end of the body and configured to receive and introduce a flow of the crude oil feedstock into the flow passage of the mixing chamber; at least one dosing port positioned along the body and in communication with the flow passage, the at least one dosing port configured to introduce the at least one doing agent into the mixing chamber for mixing with the crude oil feedstock; and at least one mixing agitator positioned along the flow passage; and wherein the at least one mixing agitator is operated to substantially mix the at least one doing agent with the crude oil feedstock to form the mixture for introduction into the cavitation reactor.

In an exemplary embodiment, the system may further include a downstream mixer, separator or combinations thereof.

In some exemplary embodiments, the mixer, separator, or combinations thereof, may include centrifuge, decanter, tri-canter, settling tank, hydrocyclone, or other separation technologies, or combinations thereof, positioned downstream from the cavitation reactor and configured for separation of water, solids materials, sulfur, metal contaminants, or combinations thereof, remaining entrained in the processed crude exiting the cavitation reactor.

In an exemplary embodiment, the system may include a power source connected to the cavitation reactor and configured to supply an electrical current, a first electrical connector coupled to a portion of the cavitation reactor, and a second electrical connector connected to the rotor. In embodiments, an electrical current of approximately 10V to approximately 30V can be applied to the crude oil feedstock during operation of the cavitation reactor.

In an exemplary embodiment, the one or more dosing agents may include a bioenzyme, an oxidant, surfactant, nitrogen, ambient air, or combinations thereof.

In an exemplary embodiment, the one or more of dosing agents may include asphaltenes, paraffins, nitrogen, ozone, oxygen, peroxide, manganese, silica, carbon, graphite, polymers, surfactants, water, or combinations thereof.

In an exemplary embodiment, the contaminants may include one or more of sulfur, chlorides, metal ions, metals, or combinations thereof.

In an exemplary embodiment, the at least one mixing agitator is operated to substantially mix the at least one doing agent and the crude oil feedstock to form the mixture for introduction into the cavitation reactor at rate of approximately 0.10% or less versus a rate of flow of the crude oil feedstock through the mixing chamber.

In one aspect, the disclosure includes a mixing chamber that may include a body defining an flow passage having a flow passage defined therethough; an inlet located at an upstream end of the body and configured to receive and introduce a flow of a feedstock into the flow passage of the mixing chamber; at least one dosing port positioned along the body and in communication with the flow passage, the at least one dosing port configured to introduce the at least one doing agent into the mixing chamber for mixing with the feedstock; and at least one mixing agitator positioned along the flow passage downstream the at least one dosing port; and where the at least one mixing agitator is operated to substantially mix the at least one doing agent and the crude oil feedstock to form the mixture for introduction into the cavitation reactor.

In one aspect, a method of reducing contaminants in a fossil fuel product may include: adding a chemical blend to the fossil fuel product; regulating a temperature of the fossil fuel product; supplying the fossil fuel product into a cavitation device; and inducing cavitation and subjecting the fossil fuel product to centrifugation to separate the contaminants from the fossil fuel product with a cavitation device.

In an exemplary embodiment, the cavitation device further may include a housing that defines a cavitation chamber. with a rotor rotatably mounted therein, the rotor having at least one rotor blade having a distal peripheral surface; wherein the rotor defines define a plurality of cavitation bores, with at least one cavitation bore extending through the distal peripheral surface of each respective rotor blade, where a cavitation zone is defined in a space between the peripheral surface of the respective rotor blade and an inner surface of the cavitation chamber of the housing generally; and wherein rotating the rotor at a selected rotation rate induces continuous cavitation events within the plurality of cavitation bores of the rotor by the creation of low pressure in the cavitation bores and the formation and collapse of unstable bubbles that resultingly generate an cause shockwaves to propagate through a fossil fuel product that is present within the cavitation zone, which causes mixing and rapid reaction under mild or low to moderate shear that reduces fossil fuel product damage.

In an exemplary embodiment the chemical blend may include one or more of ozone, oxygen, peroxide, or combinations thereof.

In an exemplary embodiment, the chemical blend may include one or more of an asphaltenes or paraffin, or combinations thereof.

In an exemplary embodiment, the chemical blend may include one or more of manganese, silica, carbon, graphite, polymers, surfactant packages used in lube oils, or combinations thereof.

In an exemplary embodiment, the contaminants may include one or more of sulfur, iron, chlorides, metal ions, rare earth metals, or combinations thereof.

In an exemplary embodiment, the fossil fuel product may include crude oil.

In an exemplary embodiment, the method may further include refining the fossil fuel product to form a diesel fuel, a fuel condensate, natural gas, liquidized coal, or another petroleum product.

In an exemplary embodiment, the method may further include adding a bio enzyme to the fossil fuel product with an inline injection system and mixing equipment.

In an exemplary embodiment, the method may further include adding a condensate, water, caustic, ionic liquid, or other materials to the fossil fuel product to solubilize the one or more contaminants therein.

In an exemplary embodiment, the method may further include further inducing cavitation in combination with electrochem where an electrochem amperage is maintained by a power supply so as to control radical production levels and reduce fossil fuel product damage.

In an exemplary embodiment, the method may further include regulating the temperature of the fossil fuel product by a heat exchanger, where the temperature is between approximately 90-120 degrees Fahrenheit.

In an exemplary embodiment, the method may further include adding the chemical blend to the fossil fuel product further may include: mixing the chemical blend and the fossil fuel product in a mixing chamber, where the mixing chamber is downstream the cavitation device, and wherein the mixing chamber further may include: a pipe; an inlet port affixed to the pipe; at least one dosing tube connected to the pipe; and a mixing agitator inside the pipe.

In embodiments, the at least one doing tube can connect to the mixing chamber via a dosing port along the pipe. In some embodiments, multiple mixing agitators can be used, with at least one positioned downstream from each dosing port.

According one aspect, a system for reducing contaminants in a fossil fuel product may include: a supply of fossil fuel product; a mixing chamber connected to the supply of the fossil fuel product; a cavitation device connected to the mixing chamber; wherein the fossil fuel product flows from the supply to the mixing chamber to the cavitation device; wherein a dosing agent is added to the fossil fuel product in the mixing chamber; and where the cavitation device induces cavitation and subjecting the fossil fuel product to centrifugation to separate the contaminants from the fossil fuel product.

In an exemplary embodiment, the cavitation device further may include a housing that defines a cavitation chamber, and a cylindrical rotor rotatably mounted in the cavitation chamber, the rotor having at least one rotor blade having a distal peripheral surface, where the rotor defines define a plurality of cavitation bores, with at least one cavitation bore extending through the distal peripheral surface of each respective rotor blade; wherein a cavitation zone is defined in a space between the peripheral surface of the respective rotor blade and an inner surface of the cavitation chamber of the housing generally; and where rotating the rotor at a selected rotation rate induces continuous cavitation events within the plurality of cavitation bores of the rotor by the creation of low pressure in the cavitation bores and the formation and collapse of unstable bubbles that resultingly induce shockwaves to propagate through the fossil fuel product that is present within the cavitation zone, which causes mixing and rapid reaction under mild to moderate shear that reduces fossil fuel product damage.

In an exemplary embodiment, the dosing agent or agents can comprise a chemical blend that may include one or more of ozone, oxygen, peroxide, or combinations thereof.

In an exemplary embodiment, the dosing agent or agents can comprise a chemical blend that may include one or more of an asphaltenes or paraffin, or combinations thereof.

In an exemplary embodiment, the dosing agent or agents can comprise a chemical blend that may include one or more of manganese, silica, carbon, graphite, polymers, surfactant packages used in lube oils, or combinations thereof.

In an exemplary embodiment, the mixing chamber further may include: a pipe; an inlet port affixed to the pipe; a dosing tube connected to the inlet port and extending inside the pipe; and a mixing agitator inside the pipe downstream the dosing tube; and the mixing chamber mixes a dosing agent, which can, in embodiments, include chemical blend, and the fossil fuel product in the pipe with the mixing agitator.

According one aspect, a mixing chamber for mixing a fossil fuel product and a chemical blend may include: a pipe; an inlet port affixed to the pipe for injecting a chemical blend; a dosing tube connected to the inlet port and extending inside the pipe; and a mixing agitator inside the pipe downstream the dosing tube, where the mixing chamber mixes the chemical blend and the fossil fuel product in the pipe with the mixing agitator.

According to one aspect, a system and method for reducing sulfur and other contaminants from sulfur containing materials or compounds, such as crude oil is disclosed. In various aspects, the system can include a reservoir, such as an exemplary holding tank, configured for storing a supply of crude oil and a cavitation reactor. In embodiments, the cavitation reactor includes a housing, which defines a cavitation chamber and an internal cylindrical rotor that is configured to be rotatably mounted therein the cavitation chamber. In embodiments, the rotor can have at least one or a plurality of rotor blades having a distal peripheral surface. The rotor can also define a plurality of cavitation bores, with at least one cavitation bore extending through the distal peripheral surface of each respective rotor blade. As one skilled in the art will appreciate, a defined space between the peripheral surface of the respective rotor blade(s) and the inner surface of the cavitation chamber of the housing generally defines a cavitation zone.

In operational embodiments of the system, a pump can be provided that is configured to draw a portion (e.g., a selectable quantity or a substantially continuous flow) of crude oil feedstock from the reservoir and deliver the crude oil feedstock to an inlet of the cavitation reactor. In embodiments, within the cavitation reactor, the crude oil passes through the cavitation zone while the rotor is driven to spin at a selectable rotation rate.

In operational embodiments of the system, as the rotor is rotated within the cavitation chamber, continuous cavitation events are induced within the cavitation bores of the rotor by the creation of low pressure in the cavitation bores and the formation and collapse of unstable bubbles that resultingly induce shockwaves to propagate through the crude oil within the cavitation zone, which causes mixing and rapid reaction under mild to moderate shear that reduces fuel stock damage.

In operational embodiments of the system, electrical current can be selectively applied to generate an electrical field in the cavitation zone as the crude oil is being subjected to the cavitation induced events described above, which can allow for the production of radicals. It is contemplated that the produced radicals can chemically react with sulfur that is present in the crude oil feedstock to produce a form of sulfur which can be precipitated as a solid. Operationally, it is contemplated that the produced solid form of sulfur can be separated from the fuel feedstock in a by a centrifuge that is downstream of the cavitation reactor.

In operational embodiments of the system, the crude oil can be selectively cycled through the cavitation reactor to achieve a desired sulfur content level in the processed crude oil fuel feedstock. In embodiments, the sulfur content can be based on a selected or pre-determined amount of remaining sulfur that meets or is below environmental or other regulations.

In operational embodiments of the system, the process of determining the remaining sulfur content can be automated using inline testing, e.g., as the crude oil is processed through the cavitation reactor. In embodiments, the process can be directed to achieving a desired or selected sulfur reduction while maintaining a desired viscosity and/or a desired BTU value.

In operational embodiments of the system, it is contemplated that the inventive process described herein is of a low shear nature, which should reduce physical damage to the processed crude oil feedstock, while precise control of the use of additives and use of controlled electrochemical reactions in which an electrical potential difference is generated (e.g., by application of an electrical current to the feedstock during the cavitation process) for driving a reaction between produced radicals and sulfur that is present in the crude oil feedstock can help limit chemical damage to the processed crude oil feedstock. Further, it is contemplated that the inventive process described herein can provide for the removal of iron and other metals, chlorides, and the like.

Accordingly, a system and method for reducing sulfur in crude oil that addresses the problems and shortcomings of traditional desulfurization treatments, such as, for example, removing sulfur compounds from crude oil prior to or as part of a refining process, is provided.

Still other aspects, embodiments, and advantages of these exemplary aspects and embodiments, are discussed in detail below. Moreover, it is to be understood that both the foregoing information and the following detailed description are merely illustrative examples of various aspects and embodiments and are intended to provide an overview or framework for understanding the nature and character of the claimed aspects and embodiments. Accordingly, these and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain the principles of the embodiments discussed herein. No attempt is made to show structural details of this disclosure in more detail than can be necessary for a fundamental understanding of the exemplary embodiments discussed herein and the various ways in which they can be practiced. According to common practice, the various features of the drawings discussed below are not necessarily drawn to scale. Dimensions of various features and elements in the drawings can be expanded or reduced to illustrate the embodiments of the disclosure more clearly.

FIG. 1 is a cross sectional view of an example embodiment of a cavitation reactor of the system illustrating inlet and outlet ports and an internal cylindrical rotor;

FIG. 2A is a schematic diagram illustrating an example embodiment of a system and method for reducing sulfur in crude oil that embodies principles of the present disclosure in one exemplary form;

FIG. 2B is a schematic diagram illustrating an example embodiment of a system and method for reducing sulfur in crude oil that embodies principles of the present disclosure in one exemplary form;

FIG. 3A is a sample embodiment of schematic flow diagram of process steps of an embodiment of a cavitation reactor;

FIG. 3B is a sample embodiment of a schematic flow diagram of process steps of an embodiment of a cavitation reactor; and

FIG. 4 is an example mixing chamber used in some embodiments of the disclosure.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a rotor blade” can include two or more such rotor blades unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It should be appreciated, that as used herein, terms of approximation, such as a “about” or “approximately,” refers to being within 10% margin of error.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “can,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular embodiment.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed but are used merely as labels to distinguish one claim element having a certain name from another element having a same name (but for use of the ordinal term) to distinguish claim elements.

Disclosed are components that can be used to perform the disclosed methods and apparatus. These and other components are disclosed herein, and it is understood that when combinations, subsets, interactions, groups, etc. of these components are disclosed that while specific reference to each various individual and collective combinations and permutation of these cannot be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and apparatus can be understood more readily by reference to the following detailed description of preferred embodiments and the examples included therein and to the Figures and their previous and following description.

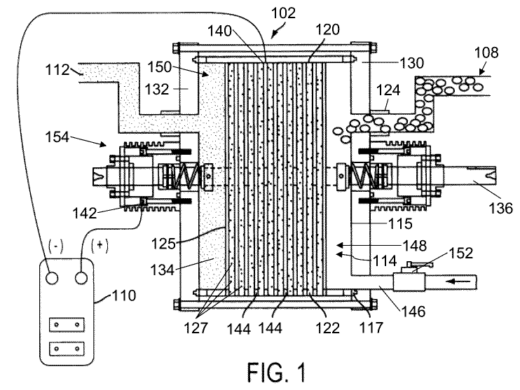

Referring now in more detail to FIGS. 1, 2A, and 3A In embodiments, a system 100 and method for reducing contaminants in a fuel product such as crude oil is disclosed. Other fuel and oil-based products also can be processed for reduction of contaminants using the systems and methods disclosed herein. Contaminants may include sulfur, iron, organic chlorides, sulfur, rare earth metals, iron, metal ions, or a combination thereof. In aspects, the system 100 can include a reservoir 104, such as an exemplary holding tank, for storing a supply of supply of a contaminant containing material, which, in embodiments, can include a crude oil feedstock, and a cavitation reactor 102.

It will be understood that while example embodiments of the system and method for reducing sulfur content and other contaminants are discussed hereafter with regard to reducing sulfur and other contaminants from a fuel product, such as crude oil, the system and methods further could be applied for removal of sulfur and other contaminants from other types of materials, including, but not limited to fuels and petrochemical materials and other compounds for which sulfur and contaminant reductions are important, according to the principles of the present disclosure. In other embodiments, contaminants may not be present in the crude oil feedstock, but chemicals and/or chemical blends may be added to the crude oil feedstock and mixed within the crude oil feedstock as part of the methods as disclosed herein. Further embodiments include using the system 100 to adjust viscosity.

In operational embodiments, the system 100 can include a pump 106 connected to the cavitation reactor 102 or the reservoir 104, e.g., being in communication with an intake line 108 or conduit extending between the reservoir 104 and the cavitation reactor 102, or in communication with the reservoir 104. The pump 106 can be configured to pump or draw a portion (e.g., a selectable quantity or a substantially continuous flow) of a crude oil feedstock from the reservoir 104, and, in embodiments, can cause the crude oil feedstock to be delivered downstream (e.g., directed along the intake line 108 or conduit) to an inlet port 124 of the cavitation reactor 102.

In embodiments, the crude oil feedstock can be pumped from the reservoir 104 and fed into the inlet port 124 of the cavitation reactor 102 at a predetermined flow rate. In some embodiments, the crude oil feedstock can be delivered in selected amounts or volumes, as opposed to being feed in a substantially continuous flow. For example, a selected volume of the crude oil feedstock that can be based on a volume of a cavitation reactor chamber 114 can be delivered for processing, with the flow of the crude oil feedstock being limited or temporary halted/slowed during a processing cycle of the cavitation reactor 102, and the flow restarted as the processing cycle is completed and the processed crude oil is released from the cavitation reactor chamber 114. Flow rates and flow volumes or amounts of the crude oil feedstock to be processed further can be based on production rates, contaminant concentrations viscosity of the cured oil feedstock etc.

In embodiments, within the cavitation reactor chamber 114 of the cavitation reactor 102, the crude oil passes through a cavitation zone 120 while a rotor 125 is selectively driven so as to spin at a desired rotation rate.

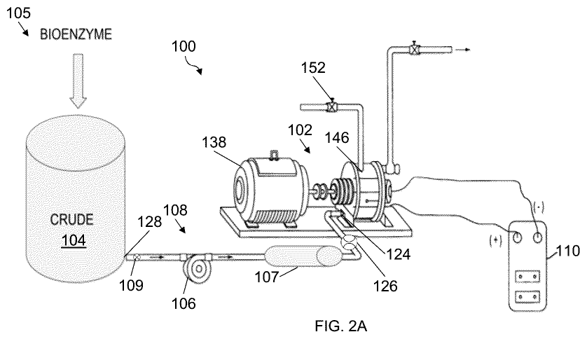

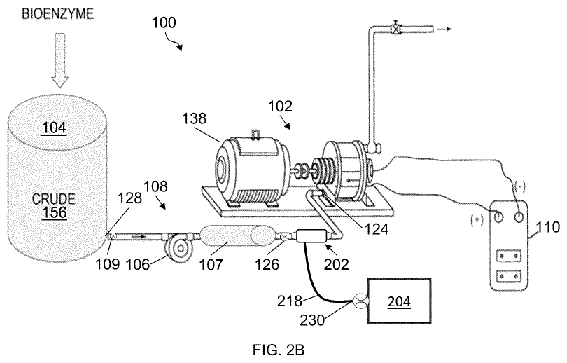

In embodiments, the system 100 can be further configured to selectively allow for the addition of a controlled amount of a contaminant processing material 105 (e.g., a dosing agent 204 explained below) upstream of the cavitation reactor 102. For example, and without limitation, it is contemplated that the controlled amount of contaminant processing material can be added or selectively metered therein to the reservoir 104 (as shown in FIG. 2) or to any intake lines 108 provided intermediate the reservoir 104 and the inlet port 124 of the cavitation reactor 102 (e.g., with the mixing chamber 202 as shown in FIG. 2B). In one exemplary embodiment, without limitation, the contaminant processing material can include adenosine-5′-phosphosulfate (APS) derived from sulfur processing bacteria Desulfovibrio desulfuricans, which can be added at selected ppm levels. In embodiments, the contaminant processing material also may include a bioenzyme, an oxidant, surfactant, nitrogen, ambient air, or combinations thereof. In addition, in embodiments, a Bioenzyme could be added to the crude oil feedstock 156 prior to its release from the storage tank.

In one aspect, a flow meter 126 can be provided that is configured to monitor the flow rate of crude oil feedstock 156 being supplied to the cavitation reactor 102 from the reservoir 104. In one aspect, the pump 106 can be operatively connected to a control system having a controller that is programed to maintain a desired flow rate of crude oil feedstock 156 through the system 100. Further, it is contemplated that the pump 106 can be configured to be operated manually. Other flow meters 126 may be included downstream the cavitation reactor 102.

In a further aspect, at least one of a shut-off valve and/or a check valve 109 can be incorporated into the system 100 between the reservoir 104 and the cavitation reactor 102. For example, a shut-off valve and/or check valve 109 can be located along the intake line 108 or conduit extending from the reservoir 104 to the cavitation reactor 102, or at the reservoir 104, such as at a junction between the intake conduit 128 and the reservoir 104 so that the flow of crude can be shut-off upstream of the intake line 108. Such an exemplary shut-off valve and/or check valve 109 can be configured to be operatively connected to the control system or optionally can be configured to be operated manually.

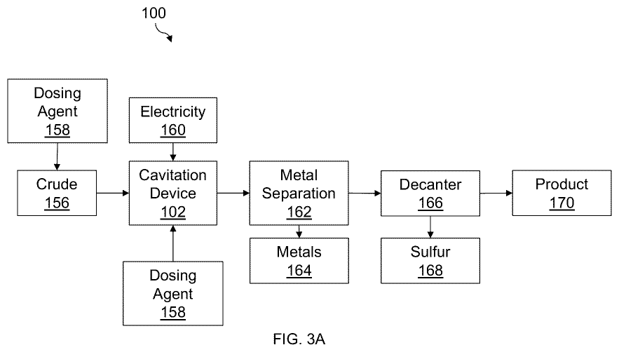

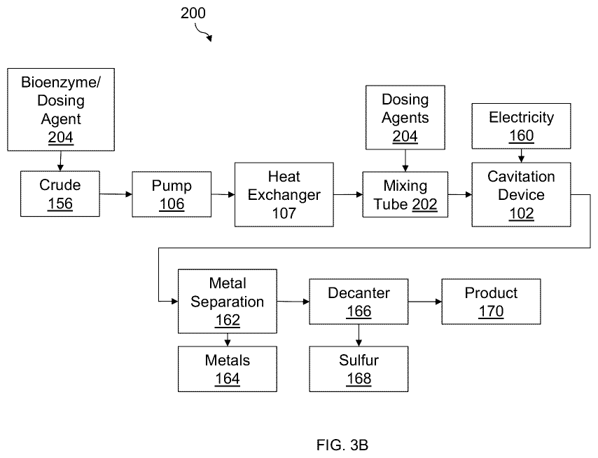

In further embodiments, selected gases can be introduced in the downstream flow of crude oil feedstock 156 prior to the inlet port 124 of the cavitation reactor 102 via valves and/or inductors 152. The valves and/or inductors 152 can be configured to be operatively connected to the control system or optionally can be configured to be operated manually. The selected gases can be separately introduced into the downstream flow of crude oil feedstock 156 and can exemplarily include oxygen, ozone, other materials such as an oxygen/ozone mixture, peroxide, bioenzyme, surfactant, nitrogen, ambient air, and the like or combinations thereof. In further embodiments, such as FIG. 3b, the selected gases may be introduced before the cavitation device via the mixing chamber 202.

In embodiments, the temperature of the wherein the temperature is regulated by heat exchanger 107. In certain embodiments, the temperature of the crude oil feedstock 156 is changed to between approximately 90-120 degrees Fahrenheit by the heat exchanger 107. The heat exchanger 107 may be manually set or controlled by the control system. In various embodiments, the heat exchanger 107 may comprise a plate heat exchangers, shell-and-tube heat exchangers, or floating head heat exchangers. In an embodiment, the crude oil feedstock 156 is heated 90-120 degrees Fahrenheit to maintain efficient flow of the crude oil feedstock 156 in the cavitation reactor 102.

In embodiments, the cavitation reactor 102 can include generally a housing 115, which may be cylindrical in shape, having a proximal end plate 130, a distal end plate 132, a peripheral inner wall 134, and within which the cavitation reactor chamber 114 is defined. In embodiments, the end plates 130/132 and the peripheral wall 134 define the cavitation reactor chamber 114 that is bounded by the inner surfaces of the end plates 130/132 and the inner surface of the peripheral wall 134. In embodiments, the cavitation reactor chamber 114 of the cavitation reactor 102 can have a cylindrical peripheral wall defining a generally cylindrical chamber or housing 115.

In embodiments, an internal cylindrical rotor 125, such as figuratively illustrated in FIG. 1, is mounted within the cavitation reactor chamber 114 of the housing on a shaft 136, which, in turn, can journaled within bearing assemblies and the like on respective end plates 130/132 of the housing.

The shaft 136 can be configured to be in operable communication with an electric motor 138, such as, for example and without limitation, a variable frequency drive, such that the motor can selectively effect the rotation of the rotor 125 within the housing 115 at a desired rotation speed. The motor 138 can be configured to be operatively connected to the control system such that the rotation speed of the rotor 125 can be operatively controlled. In embodiments, the rotation of the rotors can be controlled to provide selected variable rotation rates. For example, in some exemplary aspects, operation of rotation speeds of the rotor 125 can be between about 0 to 3600 RPM. In other embodiments rotation rates of about 100 to 3600 RPM, 100 to 3500 RPM, 100 to 3400 RPM, 100 to 3300 RPM, 1400 to 3200 RPM, 100 to 3100 RPM, 100 to 3000 RPM, 100 to 2900 RPM, 100 to 2800 RPM, 100 to 2700 RPM, 100 to 2600 RPM, 100 to 2500 RPM, 100 to 2400 RPM, 100 to 2300 RPM, 100 to 2200 RPM, 100 to 2100 RPM, 100 to 2000 RPM, or 100 to 1900 RPM, 100 to 1800 RPM, 100 to 1700 RPM, 100 to 1600 RPM, 100 to 1500 RPM, 100 to 1400 RPM, 100 to 1300 RPM, 100 to 1200 RPM, 100 to 1100 RPM, 100 to 1000 RPM, 100 to 900 RPM, 100 to 800 RPM, 100 to 700 RPM, 100 to 600 RPM, 100 to 500 RPM, 100 to 400 RPM, 100 to 300 RPM, 100 to 200 RPM can be run. Other speeds also can be used. The amount of cavitation increases with an increased speed of the rotor 125.

In further embodiments, electrical current can be selectively applied from a power source 110 to generate an electrical field in the cavitation zone 120 as the crude oil is being subjected to the cavitation induced events described above, which can allow for the production of radicals. It is contemplated that the produced radicals can chemically react with sulfur that is present in the crude oil feedstock 156 to produce a form of sulfur which can be precipitated as a solid. The housing 115 and rotor 125 may be electrically conductive materials and thereby act as either an anode or cathode, depending upon which electrical pole the housing 115 and rotor 125 are respectively connected, for creating an electrical current across the liquid in the presence of the cavitation zone 120. The power source 110 is operatively connected to the housing 115 and the rotor 125 of the cavitation reactor 102 to provide an electrical current. Additionally, an electric insulator 117 may be added to the cavitation reactor 102.

In embodiments, the reaction substantially takes place within cavitation reactor 102. In embodiments, the cavitation reactor can be the mixing device as described in detail in U.S. Pat. No. 7,771,582, the disclosure of which is hereby incorporated by reference. Radicals are formed on the surface of the electrodes and may be employed to enhance the chemical reaction(s) being conducted.

As discussed above, mixing allows for refreshing of the reactants at the electrodes for increased efficiency. Since the reaction process is rapid, there is no theoretical need for reactant retention time. As a result of the method of the present invention, the exposure of reactants to the electrodes is enhanced. Based on the surface area and the concentration of the liquor, the electric consumption can be approximately calculated.

In an exemplary embodiment, separate electrical connections can be made from a power supply to the housing and to a rotating connector on the shaft (thus electrically connected to the rotor 125). In this aspect, the separate electrical connections 140 and 142 can be configured to be electrically isolated via the use of insulation between the housing and shaft as well as the use of non-conductive bearings. The separate electrical connections create an anode/cathode gap through which the crude oil feedstock 156 flowing through the cavitation reactor is passes, which provides for application of a flow of electrical energy through the crude oil feedstock 156 being processed.

In embodiments, the rotor 125 can have at least one or a plurality of rotor blades 122 having a distal peripheral surface. The rotor 125 can also define a plurality of cavitation bores 127, with at least one cavitation bore 127 extending through the distal peripheral surface of each respective rotor blade of the rotor blades 122. In embodiments, the rotor blades 122 can comprise one or more circumferentially extending arrays of irregularities in the form of relatively shallow holes or bores 127 In the illustrated embodiment, the rotor 125 can be provided with one or more arrays of bores 127, which arrays can be separated by a void 144. It should also be understood that various numbers and configurations of arrays of bores 127 may be provided in the peripheral surface of the rotor 125 as desired. As one skilled in the art will appreciate, a defined space between the peripheral surface of the respective rotor blades 122 and the inner surface of the housing 115 generally defines a cavitation zone 120 that is within the cavitation reactor chamber 114. The number of rotor blades 122 may vary, in some embodiments there may be one rotor blade.

In addition, in embodiments, the Inlet port 124 can be provided in the housing 115 and can be connected to a conduit or intake line leading from the reservoir 104, for supplying the crude oil feedstock 156 to be mixed to the cavitation reactor chamber 114 within the housing 115. On or more intake lines 108 or supply conduits can be coupled to the inlet port 124. A liquid supply conduit is coupled to the supply conduits for supplying liquid. In embodiments, a gas supply conduit 146 can be provided and can communicate with a liquid supply conduit (e.g., the inlet port 124) for introducing and entraining gas in the form of bubbles within the stream of liquid flowing through the liquid supply conduit.

In embodiments, the rotor 125 and the end plates 130/132 of the housing 115 of the cavitation reactor 102 can define a proximal void zone 148 and a distal void zone 150. In an exemplary aspect, the inlet port 124 for receiving crude oil feedstock 156 from the reservoir 104 can be configured to be in fluid communication with the proximal void zone 148 of the housing 115. Optionally, the inlet port 124 can be configured to introduce the pumped crude oil feedstock 156 into the housing 115 in a direction that tangential to the inner surface of the peripheral wall 134 of the housing 115.

In embodiments, an outlet port 112 for dispensing processed crude oil feedstock 156 from the cavitation reactor 102 can be configured to be in fluid communication with the distal void zone 150 of the housing 115. In one exemplary aspect, the outlet port 112 can be positioned diametrically opposite to the inlet port 124. Optionally, the outlet port 112 can be configured to receive the processed crude oil feedstock from the distal void zone 150 in a direction that tangential to the inner surface of the peripheral wall 134 of the housing 115.

In operation, the rotor 125 is selectively rotated by the drive motor 138, such as an exemplary counterclockwise rotative direction when viewed from a distal bearing assembly 154. As the rotor 125 is rotated within the cavitation reactor chamber 114, continuous cavitation events are induced within the cavitation bores 127 of the rotor 125 by the creation of low pressure in the cavitation bores 127 and the formation and collapse of unstable bubbles that resulting induce shockwaves to propagate through the crude oil within the cavitation zone 120, which causes mixing and rapid reaction under mild to moderate shear that reduces fuel stock damage.

As the crude oil feedstock 156 moves into and through the cavitation zone 120, air bubbles in the crude oil feedstock 156 are bombarded by the cavitation bubbles as they form and further are impacted by the cavitation shock waves created as the cavitation bubbles collapse. This results in a “chopping up” of relatively larger air bubbles into smaller air bubbles, which themselves are chopped up into even smaller air bubbles and so on in a process that occurs very quickly. The result is an increased total composite air bubble surface area in contact with the crude oil feedstock 156.

As thus will be appreciated, while in the cavitation zone 120, highly energetic shock waves are continuously created by cavitation events in the bores 127 of the rotor 125 and these shock waves propagate through the crude oil in the cavitation zone 120 by the creation of low pressure in the bores 127 and the formation and collapse of unstable bubbles that cause propagating shockwaves that result in extreme and very rapid pressure fluctuations within the crude oil feedstock 156. In one example, the pressure fluctuations resulting from the operation of the cavitation reactor can result in pressure fluctuations that can vary between about 0 to 300 psi, or greater, on a macro level, but it is contemplated that the pressure fluctuations resulting from the operation of the cavitation reactor 102 can result in micro pressure fluctuations that can reach thousands of psi from the collapses of the formed cavitation bubbles.

In addition to creating a much larger surface area of air contacting the crude oil feedstock 156, the rapid rotary motion of the rotor 125 within the housing 115 in conjunction with the turbulent cavitation activity in the cavitation zones 120 causes the very small air bubbles that are created to be distributed through the crude oil feedstock 156 in an extremely uniform manner. This further increases the probability that oxygen molecules within the air bubbles will come into contact with sodium sulfide molecules, in an embodiment, within the crude oil feedstock 156. When air bubbles are introduced into the flow of crude oil feedstock 156, an electric current can rapidly reach an equilibrium point, where the current can remain relatively constant for a given flow of air into the crude oil feedstock 156.

When the flow rate of the crude oil and the rotation rate of the rotor 125 are properly selected and controlled, the dwell time of the crude oil feedstock 156 in the cavitation zone 120 and the shockwave energy in the cavitation zone 120 can be maintained at a level that is sufficient to create a desired degree of mixing of the crude oil with any added sulfur processing materials and/or gases, thereby providing a desired degree on interaction with sulfur present in the crude oil feedstock 156 flowing through the cavitation reactor. It is also contemplated that radical and intermediate species can also be generated through electrochemistry induced by the applied power flowing across the anode/cathode gap. The introduction of an electrical current provides a way to excite some of the electrons to produce radicals for chain cleavage to effect viscosity. In embodiments, it is contemplated that varying combinations of one or more of flow rate, cavitation rotation rate, power application rate, sulfur processing materials and/or gases can be selected and controlled to achieve a desired degree of sulfur reduction in the processed crude oil feedstock 156 from the supplied crude oil feedstock 156. It is contemplated that the present disclosure is not limited to any particular combination or combinations.

As thus will be appreciated, various shut off valves and control valves may be included in the system, such as the shut-off valve and/or a check valve 109. A similar shut-off valve may be included at the gas supply conduit 146. The shut-off valves may further operate as control valves to regulate the flow of the crude oil feedstock 156. The shut off valves and control valves may be in communication with a control system to regulate the flow of the crude oil feedstock 156.

As exemplarily shown in the embodiment illustrated in FIG. 2A, the crude oil feedstock 156 can be selectively recycled through the cavitation reactor 102 to achieve a desired sulfur or contaminant content level in the processed crude oil fuel feedstock. In embodiments, the sulfur or contaminant content can be based on a selected or pre-determined amount of remaining sulfur that meets or is below environmental or other regulations. In embodiments, the process of determining remaining sulfur or contaminant content can be automated using inline testing, e.g., as the crude oil feedstock 156 is processed through the cavitation reactor 102, or as the processed crude oil feedstock 156 exits from the cavitation reactor 102. In embodiments, the process can be directed to achieving a desired or selected contaminant reduction while maintaining a desired viscosity and/or a desired BTU value.

The treated fossil fuel product by the system makes further refining more efficient by removing contaminants.

FIG. 3A shows the system a sample embodiment of schematic flow diagram of process steps of an embodiment of the crude oil feedstock 156 of the system 100 as described in relation to FIG. 1 and FIG. 2A.

In an embodiment, the crude oil feedstock 156 can be initially is treated with a bio enzyme, an oxidant, other dosing agent, or a combination thereof. The dosing agent 158 may include sulfur processing bacteria Desulfovibrio desulfuricans, which can be added at selected ppm levels. In embodiments, the dosing agent 158 material may include a bioenzyme, an oxidant, surfactant, nitrogen, ambient air, or combinations thereof. The dosing agent 158 may be introduced to the crude oil feedstock 156 in the reservoir 104.

The crude oil feedstock 156 may be treated downstream the cavitation device 102.

In an embodiment, the cavitation device 102 may be treated with electricity 160 as indicated in FIGS. 1-213.

In an embodiment, the dosing agents 158 are introduced into the cavitation device 102 downstream the inlet 124. This direct injection of dosing agents 158, may further increase cavitation through oxygen injection and decontamination.

In an aspect, the crude oil feedstock 156 leaving the cavitation device 102 may enter a one or more of a further mixer, a separation device, or combinations thereof, located downstream from the outlet of the cavitation device 102. For example, the metal separation device 162 to separate the metals 164. In an aspect, downstream the metal separation device 162 may be a decanter 166 to separate a contaminant such as sulfur 168.

Operationally, it is contemplated that the produced solid form of sulfur and other contaminants can be separated from the fuel feedstock by a centrifuge that is positioned downstream of the cavitation reactor. This centrifuge operation also allows for the separation of water, other solids, and other impurities, effectively removing the sulfur or metal contaminants entrained in the processed crude oil feedstock 156 exiting the cavitation reactor. The centrifuge may be the metal separation device 162. In optional embodiments, it is contemplated that other conventional separation techniques such as decanter, settling, cyclonic, and the like can be utilized. For example, in embodiments, the centrifuge could be supplemented with or replaced by a decanter, tri-canter, settling tank, hydrocyclone, or other separation technologies, or combinations thereof.

In an aspect, downstream the decanter 166, the crude oil feedstock 156 is now a treated product 170 by the system 100. The treated product may be stored or further refined.

FIGS. 2B, 3B, and 4 show a system 200 substantially similar to the system 100 with, in some respects, the same components as the system 100. The system 200 further includes a mixing chamber 202 for adding dosing agents 204 into the crude oil feedstock 156 for feeding into the cavitation reactor 102.

The mixing chamber 202 allows for the introduction of the dosing agents 204 such as a bioenzyme, an oxidant, surfactant, nitrogen, ambient air, or combinations thereof as a pre-mix before entering the cavitation device 102.

Referring the FIGS. 2B and 3B, the crude oil feedstock 156, in an embodiment, may be pretreated separately with a bioenzyme or dosing agent 204 while the fossil fuel product is in the reservoir 104.

Referring to FIGS. 2B, 3B, and 4, in an embodiment, the mixing chamber 202 is included in the feedstock line before the cavitation device 102. It may be placed after the pump 106 and the heat exchanger 107, or upstream one or both the pump 106 and the heat exchanger 107. The flow meter 126 may be placed before the mixing chamber 202 for the control system to determine the rate of flow of the fuel stock entering the mixing chamber 202.

In an embodiment, the mixing chamber 202 may be cylindrical. The mixing chamber 202 may be four inches in diameter and three feet in length.

In an embodiment, the mixing chamber 202 includes a body 206. The body 206 may be cylindrical in shape with an interior chamber 207 defined by the inner surface of the body 206. The interior chamber 207 has a flow passage 208 defined therethrough. An inlet 210 is located at an upstream end of the body 206 to introduce the flow of the feedstock into the flow passage 208. An outlet 212 is located at a downstream end of the body 206 to continue the flow of the feed stock downstream the intake line 108 The inlet 210 and the outlet 212 may connect to the intake line 108 via a snap-fit, flare, flange, threaded, compression, welded, or other similar connections. The inlet 210 may include an inlet expander expand the intake line 108 to the size of the mixing chamber. The expanded size may be two inches. The outlet 212 may include reducer to return the feedstock back to the intake line size, for example the reducer of the outlet 212 may reduce the flow by two inches.

The dosing agents 204 are introduced into the flow passage 208 by a dosing port 214 positioned along the body 206. The dosing port 214 includes a dosing tube 216 that goes inside the body 206 into the flow passage 208. The dosing tube 216 may connect to the dosing line 218 via a snap-fit, flare, flange, threaded, compression, welded, or other similar connections. The dosing tube 216 may extend from an inner surface of the body 206 through a majority of the flow passage 208 tangential to the inner surface of the body 206 surface the dosing tube 216 entered there through. In an embodiment. The dosing tube 216 may extend from an inner surface of the body 206 through less than a majority of the flow passage 208 tangential to the inner surface of body 206 surface the dosing tube 216 entered there through.

The dosing port 214 may include a ball valve 220. The ball valve 220 may be used to control the flow of the dosing agents 204 into the flow passage 208. Alternatively, the ball valve 220 may act as an emergency shut off valve for the flow of the dosing agents 204. Alternative valves may be used instead of a ball valve 220 such as gate valves, butterfly valves, globe valves, needle valves, coaxial valves, angle seat valves, lift plug valves, rotating disc valves, spring-loaded Y-pattern valves, and rotary plug valves or the like. In an embodiment the ball valve 220 is connected to a control system to control the flow of the dosing agents 204. The ball valve 220 may be operated by the controller.

The dosing port 214 may include a reducer 222, for example a one-half inch reducer.

The dosing port 214 may further include a check valve 224 to allow the dosing agents 204 and the feedstock to only flow into and stay within the mixing chamber 202.

In an embodiment, a flow meter 230 may be included on each dosing line for a controller or user to read the flow of the dosing agent(s) 204.

In an embodiment, more than one dosing port 214 is included attached to the mixing chamber 202. Each dosing port 214 may introduce a different dosing agent of the dosing agents 204 or a combination thereof.

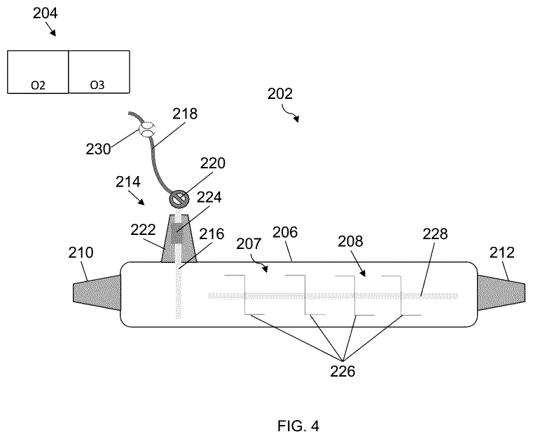

The mixing chamber 202 may include at least one mixing agitator 226 for mixing the dosing agents 204 with the feedstock within the flow passage 208. The number of mixing agitators 226 shown in FIG. 4 is four, however a there may be more or less depending on the size of the mixing chamber 202 and the application. The at least one mixing agitator 226 rotates within the flow passage 208 along a shaft 228. The shaft 228 is connecter to a motor (not shown) to spin the shaft 228 and the mixing agitators 226. The mixing chamber 202 motor may be, for example and without limitation, a variable frequency drive, such that the motor can selectively effect the rotation of the shaft 228 and rotate the at least one mixing agitator 226 within the flow passage 208 at a desired rotation speed. The rotation speed may range from about 10 rpm to approximately 200 rpm, in an embodiment. The rotation speed may depend on the size of the mixing agitators 226, the viscosity of the crude oil feed stock, and flow rate of the crude oil feedstock, or a combination thereof. The rotation speed may be selected to provide a substantially consistent distribution of the dosing agent(s) 204, but does not have to be complete mixing of the dosing agent(s) 204 in an embodiment.

In an embodiment, the at least one mixing agitator 226 is operated to substantially mix the at least one doing agent 204 and the crude oil feedstock 156 to form the mixture for introduction into the cavitation reactor 102 at rate of approximately 0.01% versus a rate of flow of the crude oil feedstock 156 through the mixing chamber 202 as measured by the flow meter 126.

In embodiments, an inline analyzer contaminant system can be configured to evaluate the contaminant levels in the processed crude oil feedstock exiting the cavitation reactor. In this aspect, the inline analyzer contaminant system can be operably connected to the control system to allow for desired operator feedback if the measured level of contaminant in the processed crude oil feedstock exiting the cavitation reactor exceeds the desired sulfur content level, which would redirect (recycle) the processed crude oil feedstock exiting the cavitation reactor back to the inlet of the cavitation reactor through a series of automated valves for remediation.

For example, and without limitation, in embodiments, testing of processed crude oil feedstock using the methodology of the present invention has shown approximately a 75% reduction in sulfur (e.g., in some embodiments, total sulfur content was reduced from about 3.1% to about 0.9%). and a reduction of iron further was achieved, e.g., in some tests, being reduced to under 1 ppm. It is contemplated that the removal of iron can be accomplished via the use of conventional magnet and centrifugation methods.

It is contemplated that the inventive process described herein is of a low shear nature, which should reduce physical damage to the processed crude oil feedstock, while precise control of the use of additives and use of electrochemistry can help limit chemical damage to the processed crude oil feedstock. Further, it is contemplated that the inventive process described herein can provide for the removal of contaminants, and the like.

Low shear mixing involves gentler action to blend ingredients with minimal degradation of material properties. Creating a low shear environment requires different levels of energy, rotational speeding, and mixing intensity. The cavitation reactor 102 receives the mixture or feedstock from the mixing chamber 202 and generate shockwaves to induce cavitation induced pressure variations that propagate through the feedstock sufficient to cause an increased reaction between produced radicals and the contaminants present in the crude oil feedstock 156 under low to moderate shear to separate at least a portion of the contaminants from the crude oil feedstock 156 while minimizing damage to the fuel product. The low to moderate shear force results in less polymer chain breakage than a high shear force. A low to moderate shear force can unfold, untangle, separate, and straighten polymer chains as the polymers are exposed to the cavitation induced pressure fluctuations in the cavitation reactor 102.

By rotating the rotor 125 at a selected rotation rate induces substantially continuous cavitation events within the plurality of cavitation bores 127 of the rotor 125 by creation of low pressure in the cavitation bores 127 of the rotor 125 and formation and collapse of unstable bubbles to create the shockwaves within the crude oil feedstock 156 within the cavitation zone. Breakage of polymer chains is determined as a function of several variables that relate to shear pressure including the rotor 125 to housing 115 clearances, the rotor 125 speed, the dwell time, temperature, energy input as determined by the motor 138, concentration of dosing agents 204,

In embodiments, the system and method of the present disclosure can be configured to house the control system that can be configured to contain the electronic controls, computer systems, programing, etc. necessary for operation of the system. Thus, in this aspect, it is contemplated that the control system of the system can include a processing system having a control module and an instrument controller that includes at least one processor and at least one memory, which can be coupled to a volatile or non-volatile memory containing a database for storing information related to the operation of the system. The memory being configured to contain instructions that, when executed by the processor, are operative to perform the essential, recommended and/or optional functions in various embodiments of the system described herein. In this aspect, the control system has at least one memory that is configured to store program instructions such that, in operation, at least one memory of the control system is configured to store program instructions that, when executed, cause the system to perform the required operations.

To regulate the operation of the system 100/200, the control system can include input devices (such as a selected one of the flow rate meters 126/226) and output devices (such as electric motor power supply (e.g., motor 138, the mixing chamber motor), shut-off valves, and control valves) that are operatively coupled to the processor(s). In embodiments, the control system is configured to allows for a real-time control and is in operative communication and control of the pump 106, the electric motor 138, the shut-off valves, control valves, and/or material and/or gas metering controllers.

In exemplary aspects, the control system can include a memory that is in communication with the processor(s) and may also include other features such as limiters, conditioners, filters, format converters, or the like which are not shown to preserve clarity. One or more operator input devices can also be coupled to the instrument controller to provide corresponding operator input to adjust/direct one or more aspects of system operation. Exemplary input devices can include, without limitation, a keyboard, mouse, pen, voice input device, gesture input device, and/or touch input device, or any other suitable input device. The control system can further include one or more output devices that are coupled to the instrument controller, such as a display, printer, and/or speakers, or any other suitable output device. In other embodiments, however, computer-readable communication media may include computer-readable instructions, program modules, or other data transmitted within a data signal, such as a carrier wave, or other transmission. Optionally, the control system can also include an audible alarm, warning light(s), or the like (not shown) can also be coupled to the controller that each respond to various output signals from controller.

In additional detail, the control system generally will be configured for implementing certain systems and methods for operating a system in accordance with certain embodiments of the disclosure. The processor(s) is configured to execute certain operational aspects associated with implementing certain systems and methods described herein. The processor(s) can be implemented and operated using appropriate hardware, software, firmware, or combinations thereof. Software or firmware implementations may include computer-executable or machine-executable instructions written in any suitable programming language to perform the various functions described. In some examples, instructions associated with a function block language may be stored in the memory and executed by the processor(s).

As one will appreciate, the memory can be used to store program instructions, such as instructions for the execution of the methods illustrated herein or other suitable variations. The memory can include, but is not limited to, an operating system and one or more application programs or services for implementing the features and embodiments disclosed herein. The instructions are loadable and executable by the processor(s) as well as to store data generated during the execution of these programs. Depending on the configuration and type of the control system, the memory may be volatile (such as random-access memory (RAM)) and/or non-volatile (such as read-only memory (ROM), flash memory, etc.). In some embodiments, the memory devices may include additional removable storage and/or non-removable storage including, but not limited to, magnetic storage, optical disks, and/or tape storage. The disk drives and their associated computer-readable media may provide non-volatile storage of computer-readable instructions, data structures, program modules, and other data for the devices. In some implementations, the memory includes multiple different types of memory, such as static random-access memory (SRAM), dynamic random-access memory (DRAM), or ROM.

The memory, the removable storage, and the non-removable storage are all examples of computer-readable storage media. For example, computer-readable storage media may include volatile and non-volatile, removable, and non-removable media implemented in any method or technology for storage of information such as computer-readable instructions, data structures, program modules or other data. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVD) or other optical storage, magnetic cassettes, magnetic tapes, magnetic disk storage or other magnetic storage devices, or any other medium which may be used to store the desired information and which may be accessed by the devices. Combinations of any of the above should also be included within the scope of computer-readable media.

The control system can also include one or more communication connections that may allow a control device (not shown) to communicate with devices or equipment capable of communicating with the control system. Connections may also be established via various data communication channels or ports, such as USB or COM ports to receive cables connecting the control system to various other devices on a network. In one embodiment, the control system can include Ethernet drivers that enable the control system to communicate with other devices on the network. According to various embodiments, communication connections may be established via a wired and/or wireless connection on the network.

The foregoing has described various embodiments of systems and methods for reduction of contaminants from hydrocarbon-based materials such as fuels and other types of petrochemicals. The disclosed systems and methods are provided to illustrate embodiments, features, and functions thereof, and those skilled in the art may conceive of alternatives or modifications that do not depart from the principles of the invention as encompassed by the appended claims, and that such alternatives or modifications may be functionally equivalent.

What is claimed is:

1. A method of reducing contaminants in a fuel product, comprising:
feeding a crude oil feedstock along a flow path;
as the crude oil feedstock moves along the flow path, adding one or more dosing agents into the crude oil feedstock to form a mixture of the crude oil feedstock and the one or more dosing agents;
regulating a temperature of the mixture;
directing the mixture into a cavitation zone of a cavitation reactor;
as the mixture flows through the cavitation zone of the cavitation reactor, operating the cavitation reactor and generating cavitation events within the mixture; and
wherein generating the cavitation events within the mixture comprises forming cavitation bubbles within the mixture and collapsing the cavitation bubbles so as to generate cavitation induced pressure variations that propagate through the mixture as the mixture flows through the cavitation zone so as to cause increased reaction and blending of the one or more dosing agents with the crude oil feedstock of the mixture under low to moderate shear conditions so as to reduce damage to the fuel product, substantially contaminants from the crude oil feedstock, substantially reduce a viscosity of the crude oil feedstock to a selected viscosity, or combinations thereof.

2. The method of claim 1, wherein the cavitation reactor comprises a cavitation chamber and a rotor rotatably mounted within the cavitation chamber, the rotor having at least one rotor blade having a peripheral surface with a plurality of cavitation bores defined therethrough; wherein the cavitation zone is defined within a space between the peripheral surface of the at least one rotor blade and an inner surface of the cavitation chamber; and wherein operating the cavitation reactor further comprises rotating the rotor at a selected rotation rate to create a low pressure in the cavitation bores sufficient to cause the formation and collapse of the cavitation bubbles so as to generate shockwaves that create the cavitation induced pressure variations that propagate through the mixture.

3. The method of claim 2, wherein operating the cavitation reactor further comprises controlling a rotor rotation rate in view of a concentration of the one or more dosing agents within the mixture, and controlling a dwell time of exposure of the mixture to the cavitation induced pressure variations, a temperature of the mixture, a range of pressures of the cavitation induced pressure variations, or combinations thereof.

4. The method of claim 1, wherein the one or more dosing agents comprise a bioenzyme, an oxidant, surfactant, nitrogen, ambient air, or combinations thereof.

5. The method of claim 1, wherein the one or more of dosing agents comprise asphaltenes, paraffins, nitrogen, ozone, oxygen, peroxide, manganese, silica, carbon, graphite, polymers, surfactants, water, or combinations thereof.

6. The method of claim 1, wherein the contaminants comprise one or more of sulfur, chlorides, metal ions, metals, or combinations thereof.

7. The method of claim 1, wherein introducing one or more dosing agents into the crude oil feedstock comprises passing the crude oil feedstock through a mixing chamber, and introducing the one or more dosing agents into the mixing chamber through at least one dosing port; and wherein the one or more dosing agents are introduced into the mixing chamber at a rate of approximately 0.10% or less of a rate of flow of the crude oil feedstock through the mixing chamber.

8. The method of claim 1, further comprising refining the fuel product to form a diesel fuel, a light fuel, a heavy fuel, a fuel condensate, gasoline, heating oil, natural gas products, or liquidized coal.

9. The method of claim 1, further comprising adding a condensate, water, caustic, ionic liquid, or other materials to the fuel product to solubilize the one or more contaminants therein.

10. The method of claim 1, further comprising applying an electrical current to the mixture so as to create an electrical potential difference sufficient for driving an electrochemical reaction in combination with generating the cavitation events within the mixture so as to control formation of radical and intermediate species of contaminant production levels and reduce fossil fuel product damage.

11. A system for reducing contaminants in a fuel product comprising:
a supply of a crude oil feedstock;
a mixing chamber connected to the supply of the crude oil feedstock, the mixing chamber including body having a flow passage defined therethrough;
wherein the mixing chamber is configured to add at least one dosing agent to the crude oil feedstock as crude oil feedstock is moved along the flow passage through the mixing chamber to form a mixture of the at least one dosing agent and the crude oil feedstock;
a cavitation reactor in communication with the mixing chamber, the cavitation reactor comprising a cavitation chamber and a rotor positioned within cavitation chamber;
wherein a cavitation zone is defined between a surface of the rotor and a surface of the cavitation chamber;
wherein the crude oil feedstock is fed from the supply into the mixing chamber; and
wherein the cavitation reactor is configured to receive the mixture from the mixing chamber and rotate the rotor to generate shockwaves of a magnitude to induce cavitation induced pressure variations that propagate through the crude oil feedstock sufficient to cause an increased reaction between produced radicals and the contaminants present in the crude oil feedstock under low to moderate shear to separate at least a portion of the contaminants from the crude oil feedstock while minimizing damage to the fuel product.

12. The system of claim 11, wherein the rotor of the cavitation reactor further comprises at least one rotor blade having a plurality of cavitation bores extending therethrough; and
wherein the rotor is rotated at a selected rotation rate to create low pressure in the cavitation bores of the rotor and formation and collapse of unstable bubbles within the mixture sufficient to cause creation of substantially continuous cavitation events within the mixture while the mixture is present to create the shockwaves within the crude oil feedstock within the cavitation zone.

13. The system of claim 11, wherein: the mixing chamber further comprises:
an inlet located at an upstream end of the body and configured to receive and introduce a flow of the crude oil feedstock into the flow passage of the mixing chamber;
at least one dosing port positioned along the body and in communication with the flow passage, the at least one dosing port configured to introduce the at least one doing agent into the mixing chamber for mixing with the crude oil feedstock; and
at least one mixing agitator positioned along the flow passage; and
wherein the at least one mixing agitator is operated to substantially mix the at least one doing agent with the crude oil feedstock to form the mixture for introduction into the cavitation reactor.

14. The system of claim 13, wherein the at least one mixing agitator is operated to substantially mix the at least one doing agent and the crude oil feedstock to form the mixture for introduction into the cavitation reactor at rate of approximately 0.10% versus a rate of flow of the crude oil feedstock through the mixing chamber.

15. The system of claim 11, further comprising a centrifuge, decanter, tri-canter, settling tank, hydrocyclone, or combinations thereof, positioned downstream from the cavitation reactor and configured for separation of water, solids materials, sulfur, metal contaminants, or combinations thereof, entrained in the crude oil feedstock exiting the cavitation reactor.

16. The system of claim 11, further comprising a power source connected to the cavitation reactor and configured to supply an electrical current, a first electrical connector coupled to a portion of the cavitation reactor, and a second electrical connector connected to the rotor; and wherein an electrical current of approximately 10V to approximately 30V is applied to the crude oil feedstock during operation of the cavitation reactor.

17. The system of claim 11, further comprising a supply of a bioenzyme, an oxidant, surfactant, nitrogen, or a combination thereof, in communication with the supply of the crude oil feedstock; and wherein the bioenzyme, oxidant, surfactant, nitrogen, or a combination thereof is added to the supply of the crude oil feedstock upstream from the mixing chamber.

18. The system of claim 11, wherein the mixing chamber comprises a plurality of dosing ports each configured to introduce at least one dosing agent into the mixing chamber; wherein the one or more of dosing agents comprise asphaltenes, paraffins, nitrogen, ozone, oxygen, peroxide, manganese, silica, carbon, graphite, polymers, surfactants, water, or combinations thereof.

19. The system of claim 11, wherein the contaminants comprise one or more of sulfur, chlorides, metal ions, metals, ambient air or combinations thereof.

20. A system, comprising:
a mixing chamber, comprising:
a body having a flow passage defined therethrough;
an inlet located at an upstream end of the body and configured to receive and introduce a flow of an oil-based feedstock into the flow passage of the mixing chamber;
at least one dosing port positioned along the body and in communication with the flow passage, the at least one dosing port configured to introduce the at least one doing agent into the mixing chamber for mixing with the oil-based feedstock; and
at least one mixing agitator positioned along the flow passage,
wherein the at least one mixing agitator is operated to substantially mix the at least one doing agent and the oil-based feedstock to form a mixture; and
a cavitation reactor located downstream from the mixing chamber, and adapted to receive the mixture from the mixing chamber;
wherein the cavitation reactor is operable to generate shockwaves of a sufficient magnitude to induce cavitation induced pressure variations that propagate through the mixture so as to cause an increased reaction between produced radicals and the contaminants present in the mixture under low to moderate shear conditions to separate at least a portion of the contaminants from the feedstock while minimizing damage to the feedstock.
